(19) United States
(12) Patent Application Publication
(10) Pub. No.: US 2013/0290232 A1
(43) Pub. Date: Oct. 31, 2013

(54) IDENTIFYING NEWS EVENTS THAT CAUSE A SHIFT IN SENTIMENT

(71) Applicants: Mikalai Tsytsarau, Trento (IT); Themis Palpanas, Trento (IT); Maria G. Castellanos, Sunnyvale, CA (US); Umeshwar Dayal, Saratoga, CA (US); Meichun Hsu, Los Altos Hills, CA (US)

(72) Inventors: Mikalai Tsytsarau, Trento (IT); Themis Palpanas, Trento (IT); Maria G. Castellanos, Sunnyvale, CA (US); Umeshwar Dayal, Saratoga, CA (US); Meichun Hsu, Los Altos Hills, CA (US)

(21) Appl. No.: 13/460,541

(22) Filed: Apr. 30, 2012

(51) Int. Cl. G06N 5/02

(52) U.S. Cl. 706/46

(57) ABSTRACT

A method identifies news events that cause shifts in sentiments. The method includes compiling a sentiment time series, the sentiment time series expressing a shift in sentiment; compiling a news events time series; correlating the sentiment and news events time series; identifying from the correlation news events that caused a shift in sentiment and predicting if a selected news event may cause a shift in sentiment in the future.

### BACKGROUND

The Internet provides opportunities for people to express their opinions about a variety of topics and events. Mechanisms exist to collect and analyze these opinions.

### DESCRIPTION OF THE DRAWINGS

The detailed description refers to the following drawings in which like numerals refer to like items, and in which:

FIG. 1 is a schematic illustration of a framework in which sentiments may be analyzed;

FIG. 2 illustrates an example of a system that may be used to analyze sentiments;

FIGS. 3A and 3B illustrate an example of the convolution of a news event sequence with a media response function, resulting in a news feature time series;

FIGS. 4A-4D illustrate an example of the correlation between sentiment contradiction level, derived from a sentiment feature time series, and a news events sequence, obtained by applying a deconvolution to a news feature time series; and

FIGS. 5-10 are flow charts of an example method for identifying news events that have caused, or may cause, a shift in sentiments.

### DETAILED DESCRIPTION

Media convergence provides opportunities for analysis of expressed sentiments. The sentiments may be expressed in diverse media sources. The sentiments may be expressed by diverse individuals. An example of a media convergence mechanism is the Internet. Because of its ubiquitous nature, and its capacity to aggregate numerous and diverse media sources, the Internet provides an ideal environment for a wide range of people to express their opinions or sentiments about events and topics. These sentiments may be aggregated and analyzed using sentiment analysis techniques. Sentiment analysis techniques can extract sentiment polarities, which may expressed in text, aggregate the sentiments, and extract a representative summary of sentiments on a feature-by-feature, event-by-event, or topical basis. While sentiment summaries can capture contradictory sentiments, and sentiment trend monitoring can capture sentiment shifts and sudden changes in volume of expressed opinions or other parameters of the trend, the methods, which are able to identify the causes of the contradictions, shifts and sudden changes in opinion, are not well developed. Discovering the cause of these changes would enable companies to analyze hidden dependencies between opinions across topics and better understand the likes and dislikes of people to react accordingly.

Disclosed herein is a framework for news event modeling, that may be instantiated in one or more of the herein disclosed example systems and corresponding methods, and that allow researchers to identify news events that have triggered, or may trigger, visible changes in sentiments, by coherently analyzing and correlating corresponding sentiment and news event time series. The systems and methods may be used to predict possible sentiment shifts based on a news event currently under observation. The framework for news event modeling provides the capability for determining or estimating a time and duration of news events by observing a time series of news story publications, and then correlating these data with a time series of a sentiment-based interestingness function. The systems and methods use sentiment analysis and contradiction detection, and create a model of relationships between sentiment changes and news events so as to better understand peoples' likes and dislikes.

While the framework for news event modeling will discuss a specific application to the Internet as a source of news events and corresponding sentiments, the framework is not so limited, and the framework for news event modeling may be applied to any environment in which individuals are able to express opinions about events that are reported and thus may be correlated to the opinions. For example, the framework could be applied to a large Federal government department. Such departments frequently have numerous publications, both in electronic form (e.g., email, internal, local area network) and mechanisms that allow departmental personnel to express opinions (e.g., ombudsmen, online suggestion boxes).

The herein disclosed example systems and example methods monitor various media sources to detect news events and to detect sentiments, extract information related to the news events and sentiments, aggregate the extracted information, analyze the aggregated information, generate news and sentiment time series from the extracted and analyzed information, correlate the news and sentiment time series, identify from the correlation, news events that appear to have caused changes in the sentiments, and describe the identified news event.

News events may be described in various media sources. One such media source that may be particularly well suited to support the herein disclosed is Web-based documents; that is, in general, any electronic document. Another media source may be a broadcast news story or a broadcast editorial program. The broadcast news stories and editorial programs may be delivered over the Internet as well as over other, more traditional mediums such as broadcast television, and print newspapers, magazines, pamphlets, billboards, and any other medium that is capable of expressing information that relates to, describes, or reports a news event. For simplicity of the following discussion, these and other media sources will be termed Web documents, or even more simply, just documents, although other documents, both electronic and hard copy may be used in the herein disclosed framework for news event modeling.

Sentiments also may be expressed in a variety of media sources, and to simplify the following discussion, these media sources from which sentiments are extracted also will be referred to as documents. As used herein, sentiments express an individual's opinion about a specific event, topic, or feature, such as a news event.

The term news event, as used herein, refers to an actual event, feature, or topic that receives news coverage on a certain continuous, stand-out time interval, and is reported on by news or media sources in such a manner as to bring the event, feature, or topic to the attention of a large number of people. To simplify the discussion, a topic, event, or feature is referred to hereinafter as a news event.

The term news story refers to a description or reporting of a news event in a document.

The term news sequence refers to a series of news events for the same topic.

The terms news sources and media sources generally refer to entities that publish documents reporting news events. For example, an online newspaper is a news source and/or a media source.

News events may be measured by their popularity—how frequently the news event is mentioned, the amount of time and space given to the news event, and specific media channels over which the news event is promulgated, for example. The framework may allow determining the time and longitude of a news event. Longitude, as used in this context, refers to a measure of time associated with a news event. For example, the longitude may refer to a half-life time during which popularity drops by a factor of two, or the overall time that a news event persists as a news story in various media. However, since a number of news stories concerning a specific news event, and a number of documents carrying those news stories, may “decay” at an exponential rate following an initial occurrence of the news event, the overall time may appear to be an upper-bound estimate. Moreover, the half-life time is based solely on the exponential decay assumption, and may not be universally applicable. The disclosed methods and systems identify longitude and importance of an event using a deconvolution, which estimates the above parameters in a precise way through the use of a proper media response function.

The operation of the framework begins with computing a sentiment interestingness time series for a particular news event, taking as an input raw sentiment data and generating an interestingness measure based on an interestingness function (e.g., based on a contradictions measure or sentiment volume). Next, the framework computes a time series of frequency or popularity of that news event among news sources. Then, the framework allows for analysis of the computed sentiment and news time series, and determination of the time lag between news events and sentiment shifts, level of correlation, and, finally, probability of their causality. After that, the framework supports evaluating news articles for a specific time interval. In an embodiment, the analysis of news articles for a specific time interval is executed as directed by a user. In another embodiment, logic in the framework is used to determine if the sentiment time series displays enough sentiment variation to warrant analysis for a specific time interval. This evaluation involves applying a deconvolution and probabilistic modeling to recover the time and longitude of the relevant news event necessary to assign the corresponding articles and automatically extract the essence of what happened in the news event.

The herein disclosed news event modeling is built upon the idea that the publishing dynamics of the news media can be described by a special media response function mrf(t), determining the resulting frequency of documents that contain news stories about news events. The media response function can be seen as a model of the reaction of mass media to a news event; that is, the response function models a likelihood of the delayed publication of news stories related to a news event. Much like in a phone conversation, where non-ideal circuits create an echo effect, news media tend to re-publish, cite, and discuss previous news stories, creating unwanted “noise.” Moreover, the peak intensity of news story publications does not always coincide with the peak importance of the news event. The herein disclosed framework uses deconvolution (a popular technique for improving audio or image quality) to address these problems and recreate the original news event sequence. This deconvolution opens a possibility of recovering the original news event sequence, its varying importance, and its time dimension.

Since the framework is based on a deconvolution, the framework can accommodate various response functions, suitable for different cases, subject to describing the resulting publication dynamics by a differential equation. Additionally, the framework incorporates a process of automatic news event annotation from news stories based on, for example, contrasting momentary (local) and usual (global) popularity of keywords. To eliminate noise and make the above analysis more robust, the systems and methods map news stories to news events using a probabilistic model with automatically identified parameters.

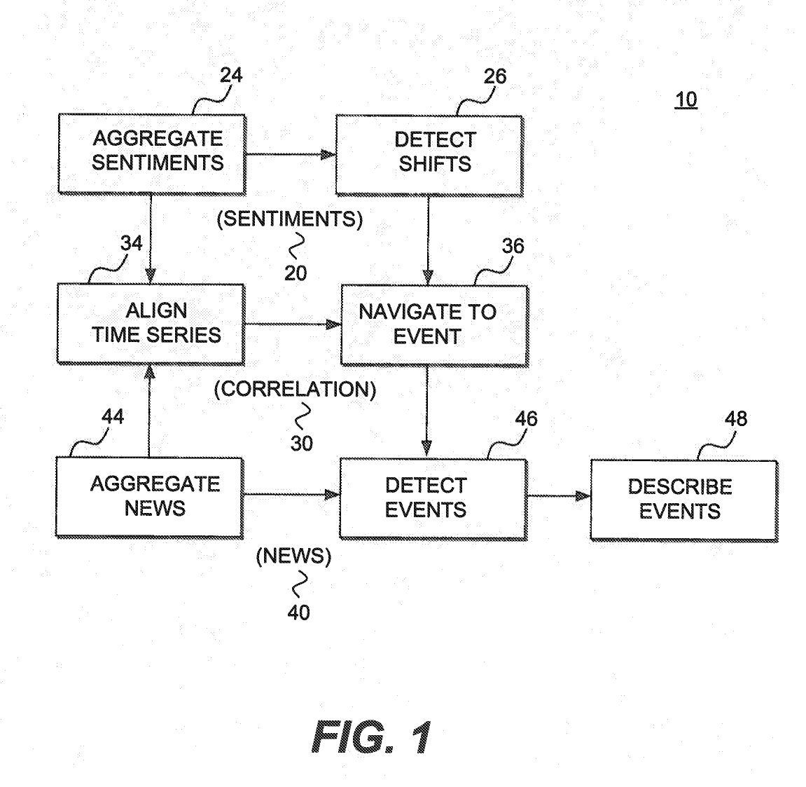

FIG. 1 is an example framework that identifies news events based on an analysis of sentiment shifts. In FIG. 1, framework 10 includes three layers: a sentiment layer 20 that aggregates and analyses sentiments, a correlation layer 30 that aligns time series for both sentiments and news events, and a news layer 40 that detects, aggregates and describes news events. The sentiment layer 20 includes a function 24 for aggregating sentiments and a function 26 for detecting sentiment changes. The correlation layer 30 includes a function 34 for aligning time series and a function 36 for navigating to an event. The news layer 40 includes a function 44 for aggregating news, a function 46 for detecting news events, and a function 48 for describing news events.

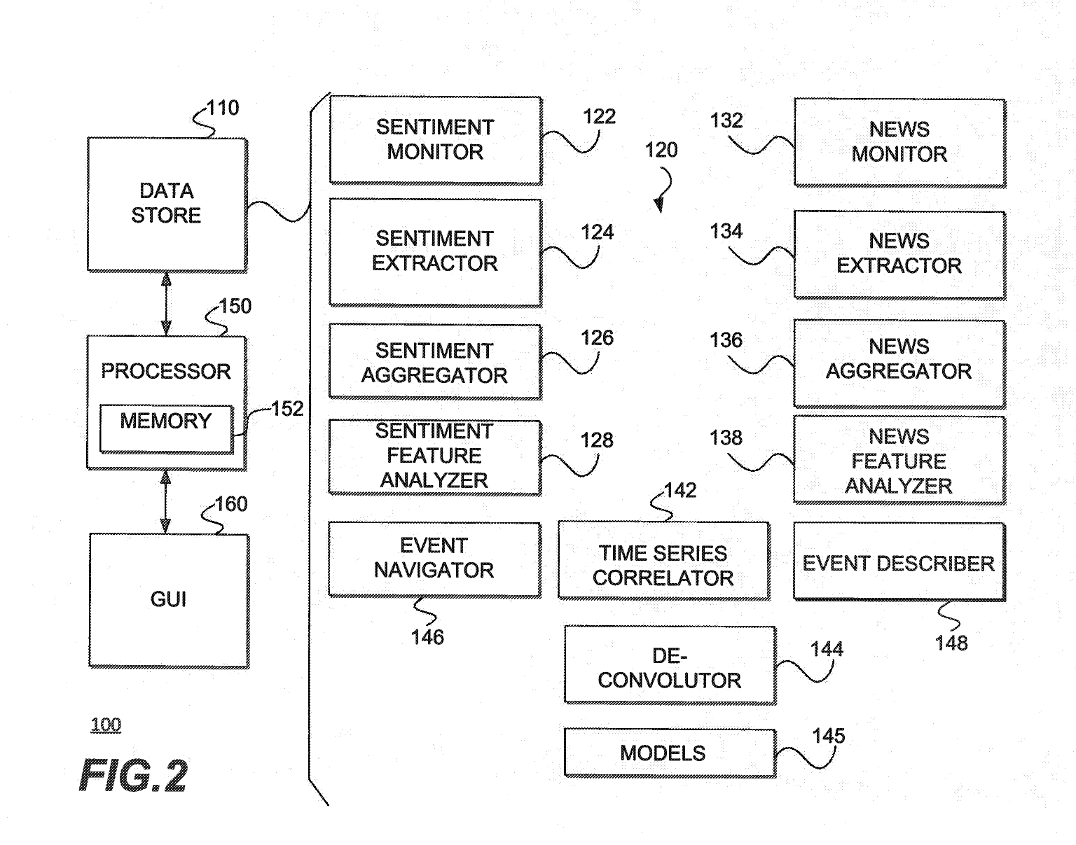

FIG. 2 illustrates an example system that supports identifying news events based on an analysis of sentiment shifts. In FIG. 2, system 100 includes data store 100, which stores analysis program 120, and which is accessible by processor 150. Processor 150 is coupled to graphical user interface 160. Processor 150 includes memory 152. Processor 150 loads some or all of the programming of analysis program 120 into memory 152, and executes the machine code of analysis program 120. Processor 150 may present the results of the analysis on GUI 160.

Analysis program 120 includes sentiment monitor 122, sentiment extractor(s) 124, sentiment aggregator 126, and sentiment feature analyzer 128. These modules apply to the sentiment layer 20 of FIG. 1. The analysis program 120 also includes news event monitor 132, news extractor(s) 134, news aggregator 136, and news feature analyzer 138. These modules apply to the news layer 40 of FIG. 1. The analysis program 120 further includes time series correlator 142, de-convolutor 144, event navigator 146, event describer 148, and models 145. The function of these components is described below.

The processor 150 operates on sentiment-feature data collected as a time series of numeric values, cf(t). The sentiment feature time series cf(t) is derived from sentiments for a particular topic and represents time-varying interestingness measures. Topics may be input by an operator of the system. The topics may be input to both the sentiment monitor 122 and the news monitor 132 to monitor for, and allow the extraction of, sentiments and news, respectively. For example, the system operator could input “all sentiments and news for topic ‘TouchPad.’” The sentiments and news features may be extracted automatically from documents by keywords appearing in a title, term frequency-inverse document frequency (TF-IDF), latent Dirichlet allocation (LDA), or other methods. The extracted news and sentiment features may be matched based on co-mentioning of keywords. In an embodiment, a topic is chosen based on a number of expressed individual sentiments. Along with the sentiment time series, the processor 150 uses an interestingness measure-specific correlation function p(cf, nf), which the processor 150 uses to compute a real-valued correlation coefficient between cf(t) and a news feature time series represented by a function nf(t).

More specifically, the processor 150 operates to solve a general problem that can be decomposed into a set of two sub-problems:
Given pp(cf,nf), cf(t) and nf(t), determine a time lag between the two time series, or a list of several most probable time lags, ranked according to their correlation coefficient.
Having identified an interesting sentiment change at a time t, determine and annotate events that preceded this situation by analyzing relevant news story (stories).
   A solution to the above-stated problem may involve modeling a news-sentiment interaction to allow identification of a causative relevant news event. Similarly, news stories and news events have their own kind of interaction, and this interaction is modeled and analyzed by the system 100 for an accurate aggregation of news stories. Finally, a solution to the problem allows analysts to predict future sentiment shifts based on a selected news event.

Returning to FIG. 1, the general approach to solving the causative news event identity involves three general areas of data acquisition, inquiry and analysis: news layer 40, sentiment layer 20, and correlation layer 30. These layers represent independent data collection, inquiry, and analysis streams. Thus, these layers are universally applicable to analysis of news events and responsive sentiments. For example, the correlation layer 30 works with an abstract time series, and although the correlation layer 30 is used to map the corresponding points between sentiment and news time series, the mapping may be done at a time series level.

Both news and sentiment layers provide time series data for correlation layer 30, which, given a proper measure of correlation, may be able to re-align the time series according to causality and a time lag, and provide a mechanism for accessing relevant time intervals in both series.

The sentiment and news event time series are generated with respect to specific topics, but the topics need not be identical. However, the strongest correlations are likely to exist when the topics are identical or closely related. Initially, topics may be judged identical based on a keyword comparison, for example. Nonetheless, even topics that are not too closely related may affect each other, and hence may show some correlation. For example, a change in sentiment towards “beer” may be caused by news stories published about cigarettes, rather than only news stories having beer as a topic. This situation may show an even stronger correlation if there are no news events present in the time series of the highest correlation at a time interval corresponding to a sentiment shift. Accordingly, the system 100 may locate and analyze news events in a time series for other topics, by the order of their correlation.

Returning to FIG. 2, sentiment monitor 122 accesses media sources and scans documents in those media sources to determine if the documents express any views or opinions (i.e., sentiments) that may relate to any topic (i.e., relate to an as-yet-to-be-defined news event). The number of media sources accessed, and the frequency and duration of the access, may vary, and may be determined by an individual operating the system 100, or may be determined by processor 150 executing logic stored in data store 110.

Sentiment extractor 124 reviews documents and extracts sentiments for topics that are expressed in the documents. Note that there may be more than one sentiment extractor 124 (and more than one news extractor 134); i.e., one sentiment extractor 124 for each of different sentiment extraction methods. However, sentiment extraction and further processing may be affected by “topic-induced noise” and “classifier-induced noise.” For example, if most documents call “Galaxy Tab” a “tablet”, and a specific document being reviewed by the sentiment extractor 124 refers to “slate”, the specific document being reviewed may not be a good choice for sentiment extraction, and may not be a good choice to use when determining news event popularity. Using sentiments that are affected by these “noise” sources may result in less than optimum correlations with the news time series.

Sentiment extractor 124 may be platform-specific, i.e., sentiment extractor 124 processes documents from different sources in a different way to extract sentiments. For example, Twitter messages are short and sentiments are usually contained in emoticons, while topics are represented by #hash tags. Blog publications usually require more complex text processing to extract both sentiment and topic, while comments to articles usually contain only sentiment expressions and topics are to be extracted from the article itself. System 100 is designed to use multiple sentiment extractors.

Sentiment aggregator 126 receives and aggregates sentiments from different sources (i.e., different sentiment extractors 124) and may perform other functions or operations with the individual sentiments or the aggregated sentiments. For example, sentiment aggregator 126 retrieves (filters) sentiments (that relate to specific topics) from sentiment extractor(s) 124. Sentiment feature analyzer 128 uses the raw and aggregated sentiments data to determine and analyze the meaning contained therein, by looking at certain features of the sentiments and executing models thereon according to certain sentiment interestingness measures. Examples of sentiment interestingness measures include sentiment contradiction level and sentiment volume. These two sentiment interestingness measures may provide a good and reliable indication of changes in public opinion, and thus may be used to correlate sentiment shifts with news events.

The sentiment feature analyzer 128 analyzes the aggregated sentiments using the sentiments interestingness measurements as follows.

Sentiment volume may be considered the net amount (a sum or count) of sentiments of the same polarity expressed in a particular time interval (e.g., S⁺(t)). Sentiment volume may be defined as the sum of S⁺(t) for all values i−n of S. Some events may cause increases of sentiment volume (positive, negative or overall). For example, the announcement of a lower product price may result in increased positive volume, while negative volume may remain the same, if the negative volume is the result of other product features, such as design and performance.

A sentiment contradiction (a form of sentiment diversity) exists when there are conflicting opinions for a specific topic, published in the same time interval. This kind of contradiction can occur at one specific point of time or throughout a certain time period. Furthermore, a contradiction may occur within, for example, one document, when the document's author presents different opinions on the same topic, or across multiple documents when different authors express different opinions on the same topic.

As a measure for contradiction, the sentiment feature analyzer 128 may combine measures for aggregated sentiment and sentiment diversity. The reason for this combination is that when the aggregated value for sentiments on a specific topic and over a specific time interval is low (close to zero) while the sentiment diversity is high, the contradiction should be high. In the system 100, aggregated sentiment μₛ is defined as a mean value over all individual sentiments, and sentiment diversity is the variance σₛ. Combining the mean and variance in a single equation yields the following measure for contradictions:

W(n)·σₛ/(μ^{s})², I

where W is a weight function that takes into account the (varying) number of sentiments n that may be involved in the calculation. A small value θ>0 is added to the denominator, which allows the system 100 to limit the sentiment contradiction level when (μₛ)² is close to zero. The nominator may be multiplied by θ to ensure that sentiment contradiction level values fall within the interval [0;1] regardless of the parameters.

Overall, this approach to measuring for contradiction level represents a good choice for mining the sentiment time series and computing a correlation, since the measure provides continuous bounded values that also may be coupled with a level of confidence.

The news event monitor 132, news extractor 134, news aggregator 136, and news feature analyzer 138 function in a manner similar to the corresponding modules in the sentiment layer.

Constructing a news feature time series nf(t) for a specific topic involves the analysis of documents published from different media sources, and extraction of the features of interest. The process of constructing the news feature time series nf(t) begins with news event monitor 132 monitoring media sources for documents reporting news events. News extractor 134 extracts documents having relevant news stories about news events, and news aggregator 136 aggregates the documents from different sources to form a time series of documents to be analyzed by news feature analyzer 138. For analysis, in an example, news feature analyzer 138 may count a number of documents that have occurrences of the topic's keywords. Alternatively, this can be an estimation of the topic's popularity (e.g., as measured by the frequency of publication in the documents), or the total volume of news stories, or their average length.

In lieu of, or in addition to counting documents, the news feature analyzer 138 may perform a weighted aggregation, by summing keywords TF-IDF scores instead of counting documents. The TF-IDF weight is a numerical statistic that reflects how important a word is to a document in a collection of documents. The TF-IDF value increases proportionally to the number of times a word appears in the document, but is offset by the frequency of the word in the collection of documents, which helps to account for the fact that some words are generally more common than others. Variations of the TF-IDF weighting scheme may be used as a tool in scoring and ranking a document's relevance. TF-IDF may be used for stop-words filtering in various subject fields including text summarization and classification. One ranking function is computed by summing the TF-IDF for each query term; more sophisticated ranking functions may be used.

Alternatively, the news feature analyzer 138 may use probabilistic modeling to estimate the likelihood of a news event being described by a collection of documents over a given time interval.

The system 100 may be operated under the assumption that certain sentiment changes are preceded by a causative news event. To match the sentiment shifts to the news event, time series correlator 142 of system 100 first determines a time lag between two sequences, which are generated by sentiments feature analyzer 128 and news feature analyzer 138. This lag time τ may be determined by maximizing a cross-correlation coefficient:

max(|p(cf(t),nf(t−τ))|)

Computation of this cross-correlation coefficient is difficult, and may result in erroneous values in some circumstances. Therefore, rather than solving this equation directly, the correlator 142 may use numerical methods to estimate the boundaries of the time lag τ.

In an example, the system 100 models news event frequency (i.e., the frequency of publication of news stories about the news event) as a convolution of two functions: news events (spike) sequence and a media response function.

nf(t)=∫_{-∞}^{+∞}mrf(τ)·ef(1−τ)dτ

where mrf(t) is the media response function, and ef(t) is the actual news event sequence, which is unobserved.

To recover the actual news event sequence ef(t), the system 100 may perform a deconvolution of the news feature time series nf(t)—the task, for which the system 100 may have an exact shape of mrf(t). The media response function may be a linear or an exponential function. For example: mrf(t)=\sqrt{2τ₀}−τ₀t, or mrf(t)=1/τ₀·exp(−t/τ₀); where τ₀ is a time constant. The system 100 may be operated with the assumption that news events become obsolete and corresponding news event stories cease appearing in documents very soon after their initial appearance. One reason for this obsolescence may be media saturation: the likelihood (the temporal rate) of news event publication is usually inversely dependent on the number of news stories that have been published previously on the same news event. The system 100 may detect this obsolescence by continuing to monitor media for news stories related to the news event. Based on, for example, keyword search and analysis, the system 100 may see that previously appearing keywords no longer appear, or appear at a reduced frequency. The system 100 may use a family of exponentially or linearly decaying functions to model this behavior.

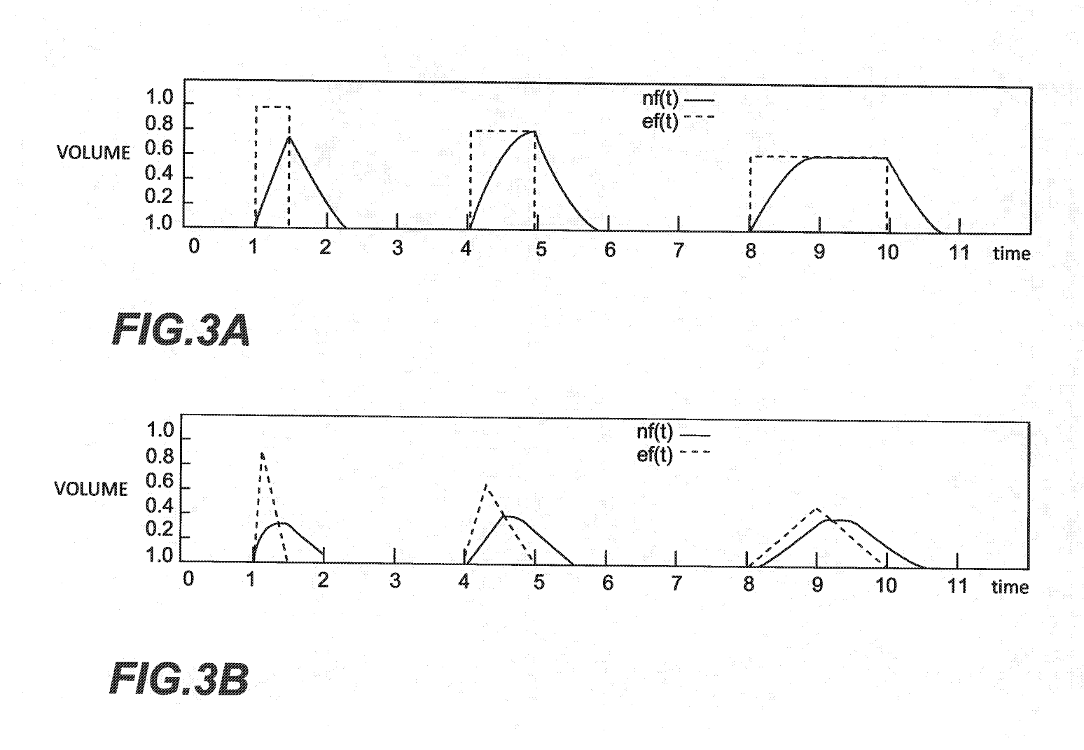

FIGS. 3A and 3B illustrate news event sequences ef(t) (shown as a dashed line) obtained from two sample news feature time series nf(t) (shown as a solid line) after a deconvolution with linear mrf(t) functions. In FIGS. 3A and 3B, the longitudes, left to right, are 0.5 days, 1 day, and 2 days. In FIG. 3A, each of the events is of a constant importance (i.e., the value of ef(t) is constant), while in FIG. 3B, the importance reaches a peak and then quickly dies off. Nevertheless, the observed maximum frequencies of news stories remain almost the same in all cases as indicated by the relatively consistent peak height of the nf(t) functions. This example demonstrates that a deconvolution can give accurate estimates of event's peak importance, longitude and the overall shape.

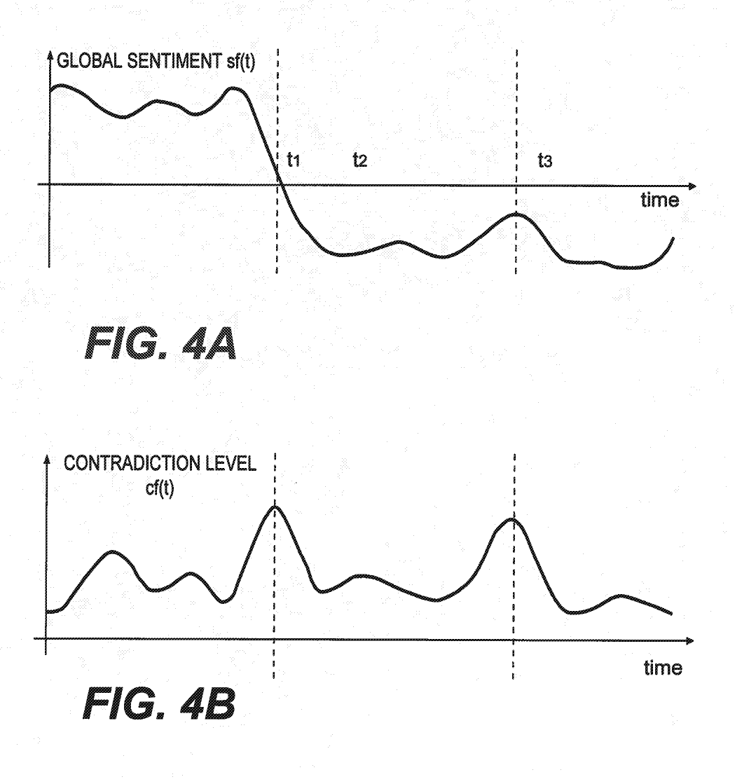

The system 100 performs a deconvolution of the news feature time series nf(t), using either the calculated, estimated or given time constant for exponential or linear media response functions. However, any other arbitrary response function can be applied in this process. FIGS. 4A-4D are an example of a news event time series that illustrates the correlation to sentiment contradiction level. FIG. 4A illustrates a global sentiment time series sf(t) and FIG. 4B illustrates a corresponding contradiction level time series cf(t). As can be seen in FIG. 4B, the contradiction level “spikes” at times t1 and t3. The spike at t1 corresponds to a decline (i.e., shift) in global sentiment. FIG. 4C illustrates a corresponding news feature time series nf(t). As can be seen at a short time interval A prior to t1, news event reports spiked. Similarly, at a short time before time t3, news event reports show a spike. A deconvolution of the news feature time series nf(t) shows three spikes, some of which correspond to the shifts in sentiments. The deconvolution is one method for extracting the (unobserved) events shown in FIG. 4D from the news feature time series nf(t).

A part of models 145 are supervised machine learning classifier models, which, in an example, may be trained on supervised correlation data between news events and sentiment shifts, and which predict possible impacts of a news event on sentiment. The classifier models may be used with methods such as Support Vector Machines, Decision Trees, and Naïve Bayesian. Other classifier models that may be used in the system 100 do not require training. The classifier models may predict the impact of the news event by observing its shape (triangular, rectangular or other), importance, longitude, buildup and decay rate and other parameters in combination or individually. Examples of these parameters can be seen in FIGS. 3A and 3B. In FIG. 3A, the height of the rectangles is a measure of importance, and the width of the rectangles defines the longitude of the events. In FIG. 3B, the tangents of the angles of the left and right corners of the triangles correspond to buildup and decay rates. The training data comes in the form of correlation/causality cases (pairs of news event—sentiment shift), and may be confirmed by an analyst and optionally refined by the system 100 with inputs from similar cases. Based on the classifier models, and a past history of correlation between two given time series, the system 100 may be used to predict if a given news event may cause a shift in sentiment.

After extracting news events and generating a news event time series, the system 100 may distinguish between subsequent and duplicate news events, and related news stories, and may map each news story to a corresponding news event. In an example, the system 100 includes a probabilistic framework that models the news events sequence and provides for mapping between news events and news stories.

In an example, the system 100 uses the principle of locality and independence of news events, according to which the occurrence of each news event is independent on all the previous news events and is determined only by the average rate λ and a time t passed from the last event. This process is described by a Poisson probability:

P=e^{-λt}

The system 100 estimates the value of λ using an auto-correlation of the news event time series. Then, the system 100 merges duplicate news events according to the probability of the duplicate news events appearing soon after the initial news event. This same probability function may be used to map news stories to news events. After a desired set of news stories is collected, the system may employ linguistic or statistical methods to extract the text of the news story, using the news extractor 134, as described below.

During a time interval there can be more than a single news story about the same news event. To account for this, the system 100 may compare the statistics of the news event of interest (falling into a specific time interval) to the same statistics calculated over the entire collection of news events (same topic, but for all intervals). This comparison may be done using unsupervised clustering (compare two cluster centroids, then find their difference), or comparing arrays of TF-IDF scores (new keywords should leave a distinct footprint in frequency). In this example, when in a time interval there are several news stories from different authors, the system 100 may aggregate them before analyzing, in order to remove individual linguistic differences.

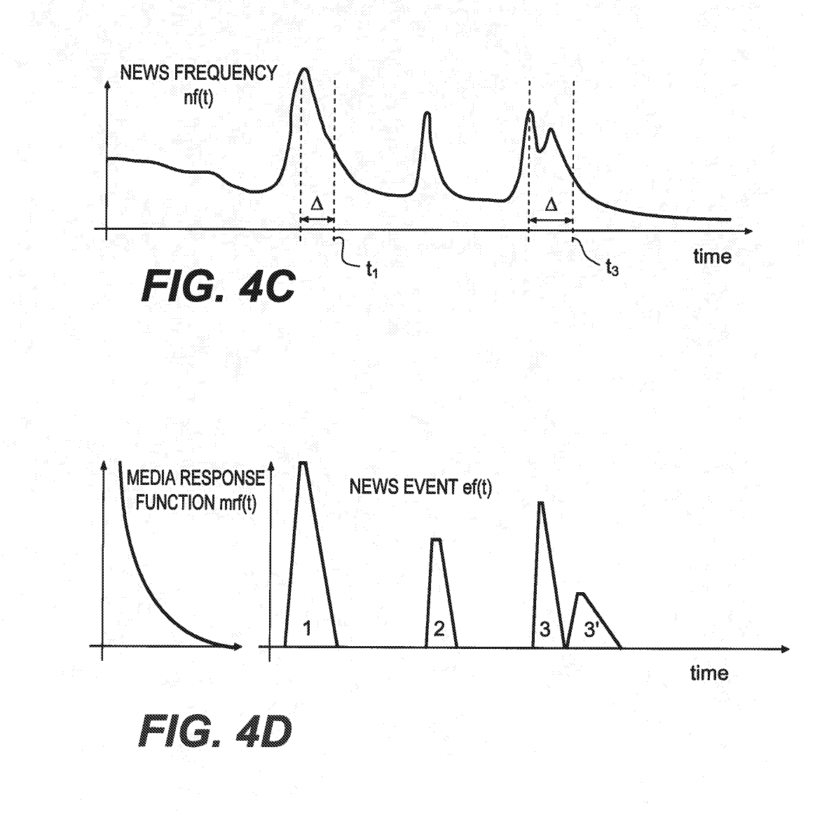

FIGS. 5-10 are flowcharts of an example operation executed by the system 100 to identify news events that cause a shift in sentiment. In FIG. 5, method 500 begins in block 510 when the system 100 compiles a sentiment time series. In block 530, the system 100 then compiles a news event time series. In block 550, the system 100 correlates news and sentiment time series. In block 570, the system 100 identifies news events causing a particular shift in sentiment. Finally, in block 590, the system 100 predicts future sentiment shift(s) based on a selected news event; i.e., based on a news event currently under analysis.

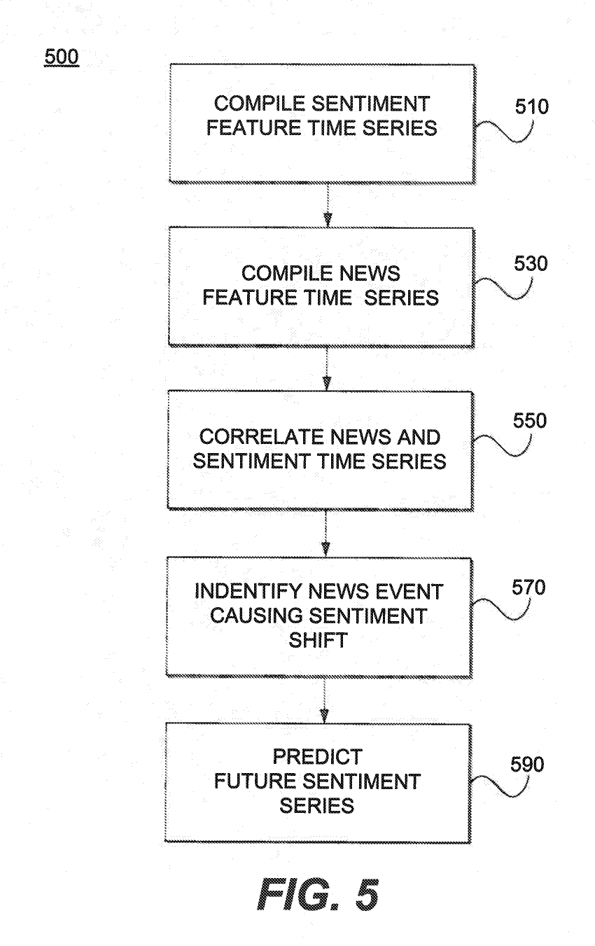

FIG. 6 is a flowchart of the method 510 of FIG. 5 for compiling a sentiment time series. In FIG. 6, method 510 begins in block 512, when the system 100 monitors documents to detect sentiments. In block 514, the system 100 detects individual sentiments. In block 516, the system 100 aggregates the sentiments and aligns the function values according to a time sequence. In block 518, the system 100 determines values for interestingness functions and identifies any sentiment shifts as shown in the time sequence.

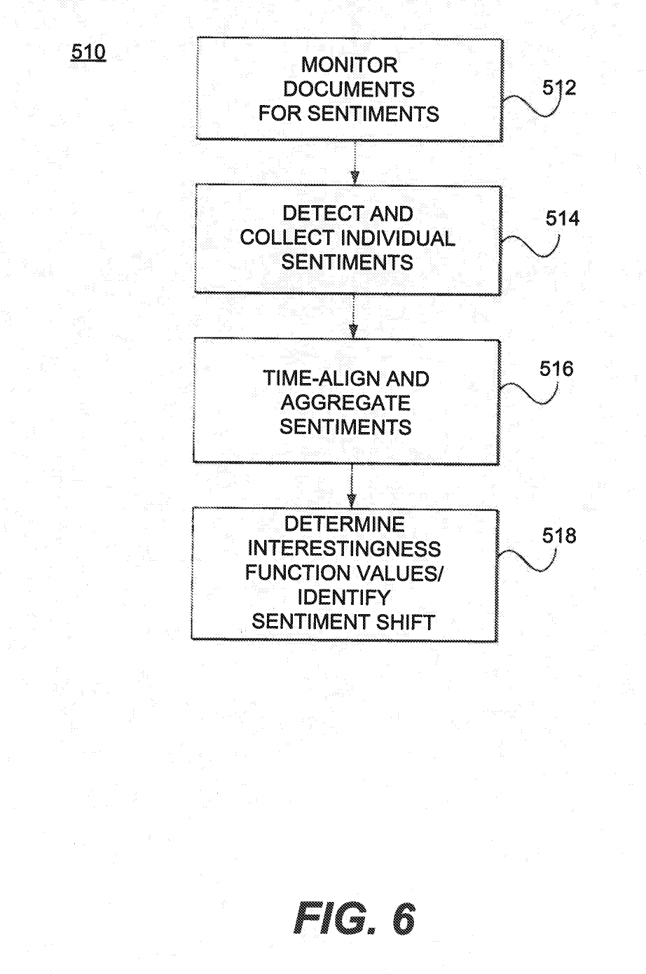

FIG. 7 illustrates method 530. In block 532, the system 100 monitors news sources and documents and detects mentions of news events. In block 534, the system 100 aggregates and time-aligns the news documents. In block 536, the system 100 extracts features into a news feature time series.

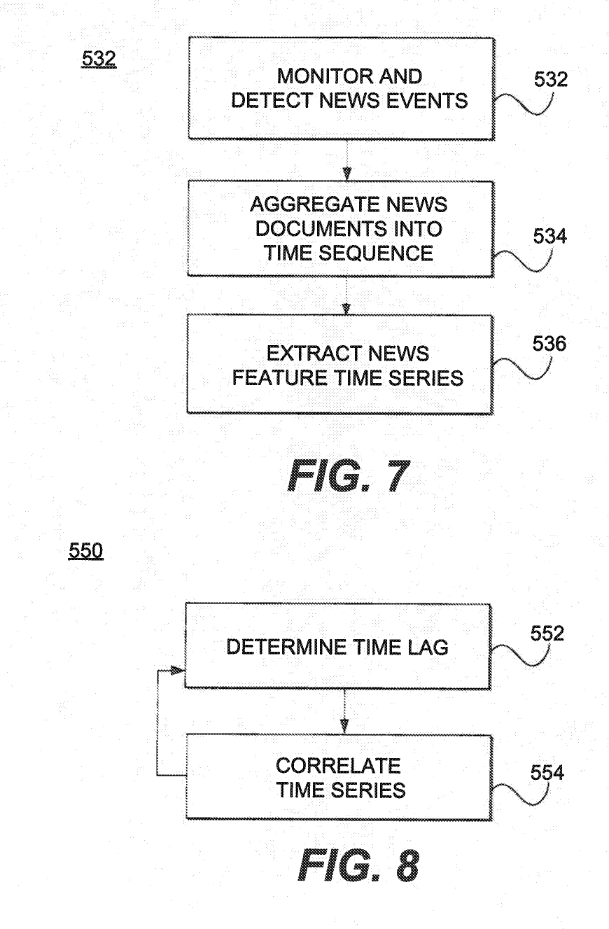

FIG. 8 is a flowchart further illustrating the method 550 of FIG. 5. In block 552 and block 554, the system 100 determines, iteratively, a time lag between the sentiments and the news time series by correlating the news and sentiment time series.

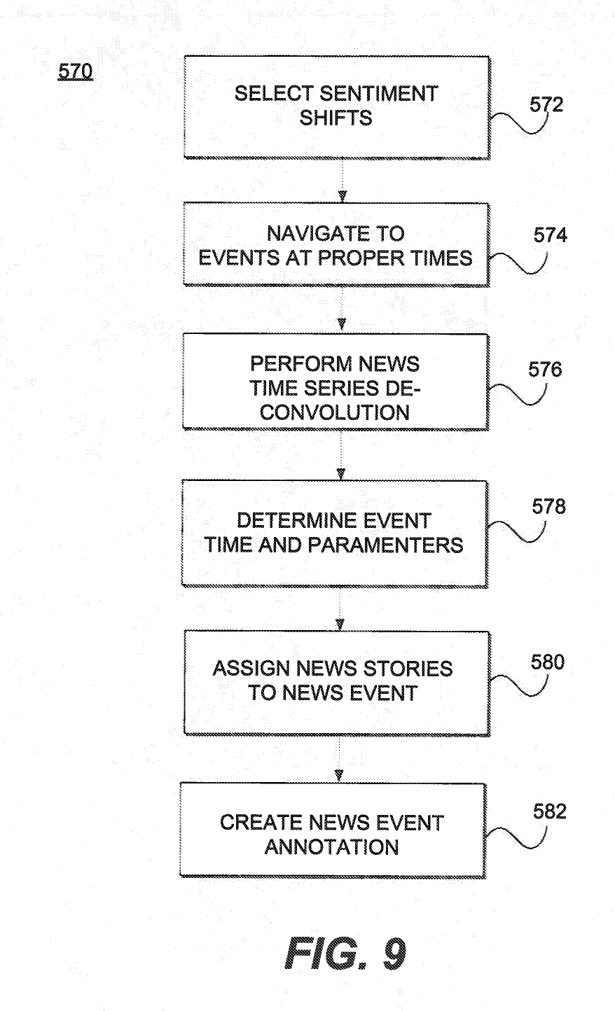

FIG. 9 illustrates method 570. In block 572, the system 100 selects sentiment shifts for analysis. In block 574, the system 100 navigates to events at times indicated by the sentiment shifts. In block 576, the system 100 performs a deconvolution of the news feature time series, if necessary and if not already done before correlating. In block 578, the system 100 determines news event time and other parameters. In block 580, the system 100 assigns news stories to news events. In block 582, the system 100 creates news events annotations.

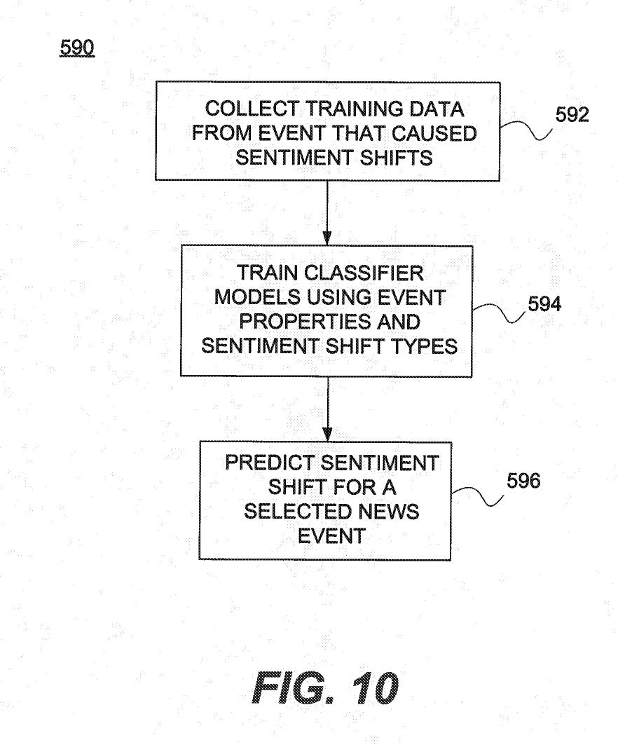

FIG. 10 illustrates the method 590. In block 592, the system 100 collects training data that can be used to train a classifier model. The training data may be news events that have been identified as having caused sentiment shifts. Once a sufficient number of such events have been identified, the system 100 trains, block 594, classifier models, using event properties and types of sentiment shifts. In block 596, the system 100 predicts sentiment shifts for a selected news event. The system 100 also may predict the type of sentiment shift. For example, the trained classifier model (of models 145) may predict a positive or negative shift in sentiment and its magnitude.

We claim:

1. A method for identifying news events that cause shifts in sentiments, wherein the news events and sentiments relate to a same topic, the method, comprising:
compiling a sentiment feature time series expressing a shift in sentiment;
compiling a news feature time series expressing popularity/importance of news events;
extracting news event parameters from the news feature time series;
correlating the sentiment and news feature time series; and
identifying from the correlation a news event that caused a shift in sentiment; and
predicting if a selected news event will cause a future shift in sentiment

2. The method of claim 1, wherein compiling a sentiment feature time series comprises:
monitoring documents for sentiments;
detecting and collecting individual sentiments;
aligning the individual sentiments according to a time sequence;
aggregating the individual sentiments with respect to the topic;
determining sentiment feature values for the aggregated sentiments; and
identifying the sentiment shift in the sentiment feature time series based on the determined sentiment feature values.

3. The method of claim 2, wherein sentiment features include sentiment volume and sentiment contradiction.

4. The method of claim 1, wherein compiling a news feature time series comprises:
monitoring and detecting news stories as reported in news documents;
developing a news document time sequence for the topic; and
aggregating the news documents and extracting the news feature time series;

5. The method of claim 4, wherein extracting the news feature time series from the aggregated news documents comprises generating keywords' TF-IDF scores from the news documents.

6. The method of claim 1, wherein correlating the sentiment and news events time series comprises:
determining a time lag between the news feature time series and the sentiment feature time series; and
correlating the news feature time series with the sentiment feature time series.

7. The method of claim 1, wherein identifying a news event that caused the shift in sentiment comprises:
selecting the shift in sentiment;
navigating to a news event correlated in time to the shift in sentiment;
assigning news stories to the news event; and
creating a news event annotation.

8. The method of claim 1, wherein:
extracting the parameters comprises performing a deconvolution of the news feature time series to determine the news event parameters, wherein the parameters include time and longitude, buildup and decay rates and importance; and
predicting the shift in sentiment comprises using a classifier, wherein the classifier takes event parameters as input data, and uses event parameters with sentiment shifts as training data.

9. The method of claim 8, wherein:
the deconvolution is performed using one of a linear media response function: mrf(t)=\sqrt{2τ₀}−τ₀t, and an exponential media response function, mrf(t)=1/τ₀·exp(−t/τ₀), where τ₀ is a time constant.

10. The method of claim 8, wherein:
prediction of the sentiment shift is performed using supervised machine learning methods, including Support Vector Machines, Decision Trees, Naïeve Bayesian.

11. A system that identifies a news event that caused a shift in sentiment, the system comprising a processor having a program, the program, comprising:
a sentiment monitor that detects sentiments from multiple sources;
a sentiment aggregator that aggregates the detected sentiments;
a sentiment feature analyzer that generates a sentiment feature time series of the aggregated, detected sentiments, the sentiment feature time series expressing a shift in sentiment;
a news detector that detects documents that report a news event, wherein the news event is relevant to the detected sentiments;
a news feature analyzer that generates a news feature time series that expresses a measure of the popularity of the news event;
a time series correlator that correlates the sentiment feature time series and the news feature time series to identify if the news event caused the shift in sentiments;
a classifier model that predicts if the news event will cause a future shift in sentiments; and
an event describer, wherein if the correlation indicates the news event caused the shift in sentiments, the event describer annotates the news event.

12. The system of claim 11,
wherein the correlator determines a time lag between the time series according to one of a maximum of a cross-correlation coefficient: max(|p(cf(t),nf(t−τ))|), and a list of most probable time lags, ranked according to a correlation coefficient; and
wherein the sentiments feature analyzer determines interestingness function values, comprising computing a sentiments contradiction value according to:
W(n)·σₛ/(μₛ)².

13. A computer readable storage medium comprising program instructions that when executed by a processor, cause the processor to:
detect sentiments;
aggregate the detected sentiments;
generate a sentiment feature time series of the aggregated, detected sentiments, the sentiment feature time series expressing a shift in sentiment;
detect documents that report a news event, wherein the news event is relevant to the detected sentiments;
generate a news feature time series that expresses a measure of the popularity of the news event;
correlate the sentiment feature time series and the news feature time series to identify if the news event caused the shift in sentiments;
identify if the news event will cause a future shift in sentiments; and
annotate the news event, wherein the news event may be one of an event that caused or will cause a shift in sentiments, or an event selected by an operator.

14. The computer readable storage medium of claim 13, wherein the processor:
performs a deconvolution of the news event time series by estimating a time constant for news events sequence, and
estimates news event parameters.

15. The computer readable storage medium of claim 13, wherein the processor performs a prediction of the news event causing a shift in sentiment time series;
and wherein the processor, in identifying the news event, annotates the news event.
